(19) United States
(12) Patent Application Publication
(10) Pub. No.: US 2025/0116353 A1
(43) Pub. Date: Apr. 10, 2025

(54) FABRICATING TRIM FOR A BALL VALVE

(71) Applicant: Dresser, LLC, Houston, TX (US)

(72) Inventors: Jeffrey Louis Johanning, Ponte Vedra, FL (US); Abdul Raoof Mohamed, Jacksonville, FL (US); Jonathan Clyde Whitten, Orange Park, FL (US); Mikhail Anisimov, Houston, TX (US); Joseph Georges Shahda, Abington, MA (US)

(21) Appl. No.: 18/896,594

(22) Filed: Sep. 25, 2024

Related U.S. Application Data
(60) Provisional application No. 63/587,914, filed on Oct. 4, 2023.

(51) Int. Cl. F16K 47/04

(52) U.S. Cl. CPC F16K 47/045

(57) ABSTRACT

A trim device for a ball valve that is configured to reduce noise. The trim device may embody a portion of an annular ring. This portion may include a noise-suppressing element, for example, openings of a shape that can modify flow of material as it passes through the ball valve. In one implementation, the portion of the annular ring fits into an opening in a throttling ball, preferably without heating the throttling ball.

### CROSS-REFERENCE TO RELATED APPLICATIONS

This application claims the benefit of priority to U.S. Ser. No. 63/587,914, filed on Oct. 4, 2023, and entitled “FABRICATING TRIM FOR A BALL VALVE.” The content of this application is incorporated by reference herein in its entirety.

### BACKGROUND

Flow controls play a role in many industrial facilities and systems. Ball valves are a type of flow control that find use in, for example, installations and networks that distribute fluids, like natural gas, vapor, water, or petroleum. One problem that subsists with these devices, though, is that the fluids may flow at rates high enough to generate vibration as it transits through the device. If left unchecked, the vibration results in loud noise, oftentimes in excess of acceptable safety levels. Many ball valves incorporate counter measures, including additional parts (or “trim”), that are meant to attenuate flow and suppress this noise.

### SUMMARY

The subject matter of this disclosure relates to trim that suppresses noise in valves. Of particular interest are embodiments of methods to fabricate parts of the trim. These embodiments are configured to reduce labor and costs in production of, for example, a throttling ball with noise suppressing components or devices that finds use in ball-style valves. These configurations may avoid certain processes, which can shorten assembly time. In one implementation, manufacturers may no longer need to heat the throttling ball to install trim pieces that contain noise suppressing features.

### DRAWINGS

This disclosure refers to the accompanying drawings, in which:

FIG. 1 depicts a perspective view of an exemplary embodiment of a trim device;

FIG. 2 depicts a perspective view of an exemplary embodiment of a trim device;

FIG. 3 depicts a perspective view of an example of the trim device of FIG. 2;

FIG. 4 depicts a perspective view of the trim device of FIG. 3 in an example of a throttling ball;

FIG. 5 depicts a perspective view of the trim device and the throttling ball of FIG. 3 in an example of a valve;

FIG. 6 depicts a perspective view of an example of the trim device of FIG. 2 in an example of a throttling ball;

FIG. 7 depicts a perspective view of an example of the trim device of FIG. 1;

FIG. 8 depicts a perspective view of an example of the trim device of FIG. 7;

FIG. 9 depicts a perspective view of an example of the trim device of FIG. 8;

FIG. 10 depicts a perspective view of the trim device of FIG. 7 in an example of a throttling ball;

FIG. 11 depicts a flow diagram of an exemplary method for fabricating a trim device and assembling a throttling valve;

FIG. 12 depicts an example of the method of FIG. 11; and

FIG. 13 depicts an example of the method of FIG. 12.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” should does not exclude the existence of additional embodiments or implementations that also incorporate the recited features.

### DESCRIPTION

The discussion now turns to describe features of the embodiments shown in drawings noted above. These embodiments address manufacturer's concerns with lead times and costs of parts that address excessive noise in ball-type valves or other flow controls. These parts are important because they attenuate noise from the valves in the field to levels that are within healthy limits for workers that perform tasks in or around this equipment every day. As noted below, the embodiments simplify assembly of a throttling ball or a throttling valve in large part because they do not require manufacturers to heat or pre-heat the throttling ball or throttling valve. This feature eliminates time-consuming and labor intensive steps from the assembly process. Other embodiments are contemplated within the scope of this disclosure.

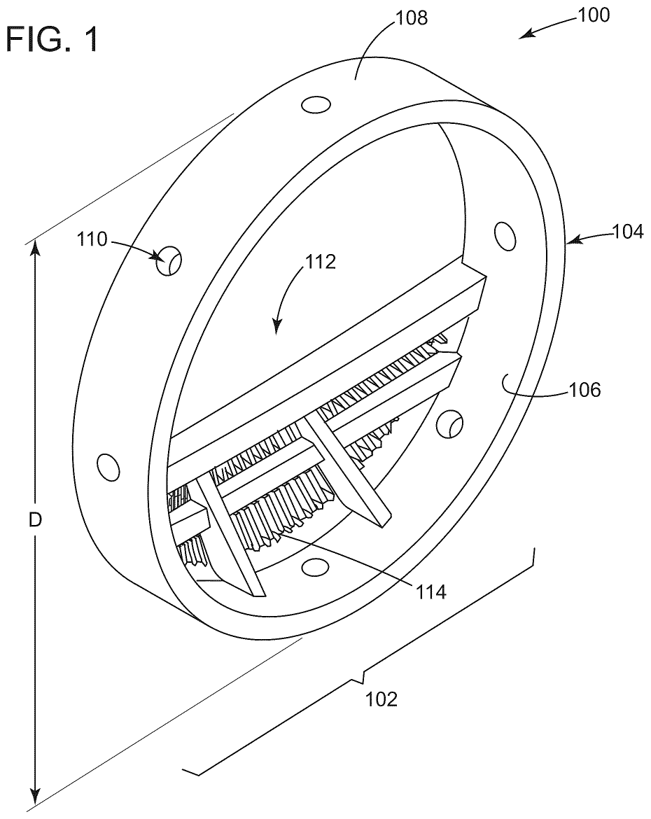

FIG. 1 depicts a perspective view of an example of a trim device 100. This example includes a body 102 preferably made of machined, cast, or printed metals, like aluminum or steel. The body 102 may form an annular ring 104 with an inside surface 106 and an outside surface 108. The annular ring 104 may also have one or more apertures 110, for example, through-holes that penetrate or extend between the surfaces 106, 108. An arrangement for the apertures 110 may locate them equally-spaced apart from one another about the annular ring 104. As also shown, a noise-reducing element 112 may reside inside of the annular ring 104. This device may form integrally with the annular ring 104, as might result from manufacture of a single, unitary piece using processes, like investment casting or additive manufacturing (“3-D printing”). This disclosure also contemplates examples in which the noise-reducing element 112 is a separate or independent piece that secures or couples to the inside surface 106, for example, using welds or fasteners. In one implementation, the noise-reducing element 112 may include openings 114 of various geometry. The openings 114 may adopt shapes that benefit noise suppression, for example, when in use in a throttling ball found in a ball-style valve or like device. Secondary processes on the annular ring 104 may reduce the outer diameter D to fit inside of the throttling ball. These processes may include “turning” on a lathe or like equipment to remove material from the outer surface 108.

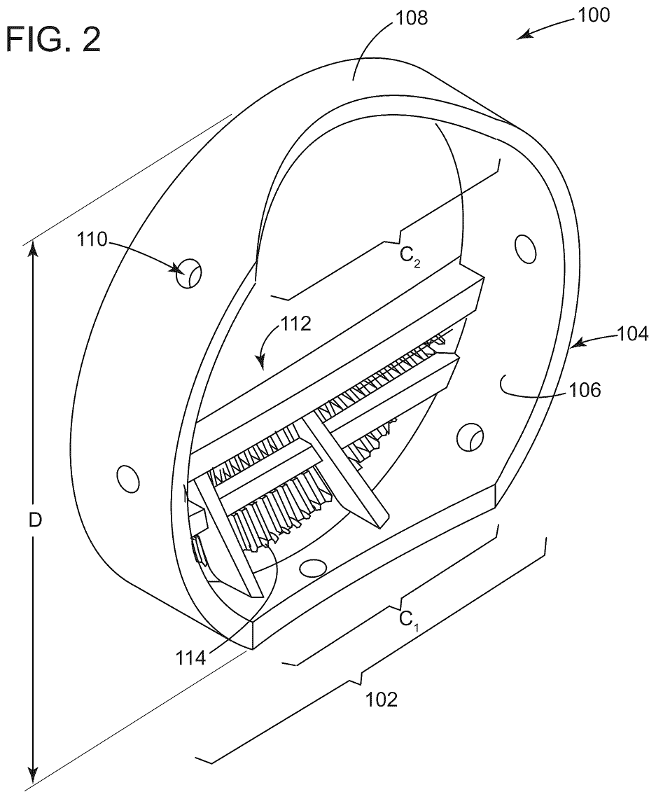

FIG. 2 depicts a perspective view of an example of the trim device 100 of FIG. 1. The body 102 may include one or more cutouts, shown here as cutouts C₁, C₂ that reside in diametrically opposing portions of the annular ring 104. The cutouts C₁, C₂ may have geometry that creates features to match features on the throttling ball. These features may include curved, bowed, or arcuate surfaces, for example, with a radius or diameter that matches a radius or diameter on the throttling ball. In one implementation, the features may form during casting or printing of the annular ring 104. Processes like cutting or machining may also find use to remove material from the annular ring 104 to for the necessary geometry or shape of the features as well.

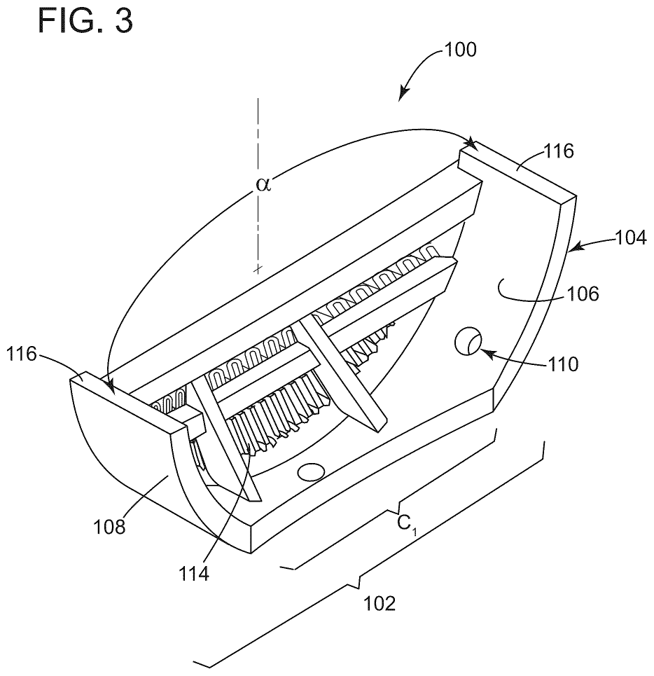

FIG. 3 depicts a perspective view of an example of the trim device 100 of FIG. 1. This example may result from processes to remove portions of the annular ring 104, preferably after turning-down the diameter D as noted above. Cutting or machining may terminate the annular ring 104 at a pair of surfaces 116, shown here as spaced-apart from one another by an angle a In one implementation, the angle a is in a range of between 120° and 180°, and, in one example, around 160°. The value for the angle a may vary pursuant to design criteria, performance parameters, or like requirements.

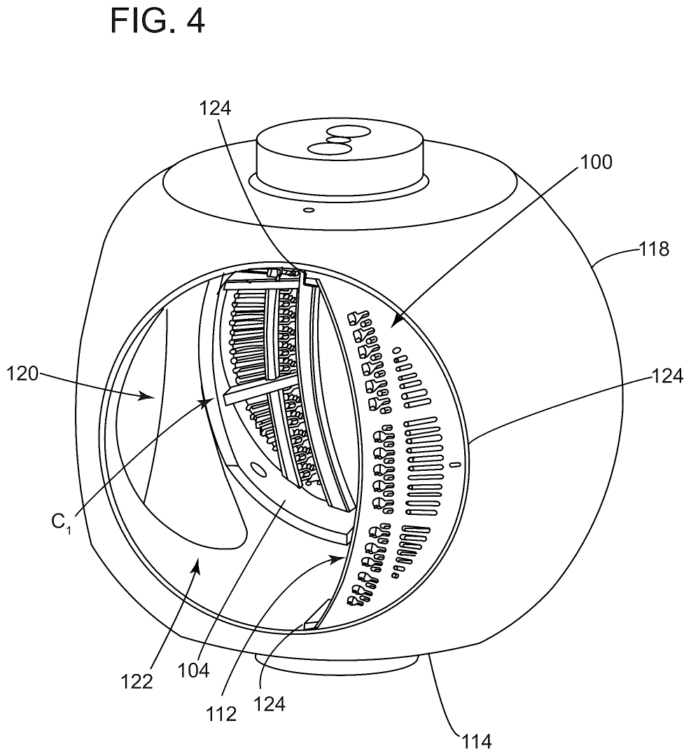

FIG. 4 depicts a perspective view of an example of the trim device 100 of FIG. 3. This example may install inside of a throttling ball 118, shown here with a hollow interior 120. Openings 122 in the throttling ball 118 may provide access to the hollow interior 120. In one implementation, the annular ring 104 may reside in one or more of the openings 122, preferably so that material that flows through the hollow interior 120 passes through the openings 114 of the noise-reducing element 112. As shown, the arcuate surface of the cutout C₁ may align with the edge of the openings 122 of the throttling ball 118. This feature may locate material of the annular ring 104 outside of the path of flow to avoid potential disruption or perturbations that could exacerbate noise. Welds 124 on one or more surfaces may secure the trim device 100 in position in the throttling ball 118.

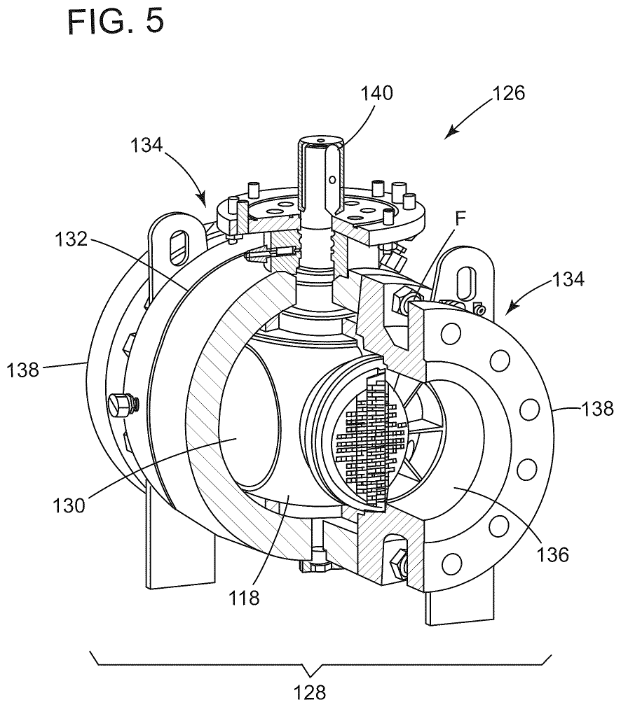

FIG. 5 depicts a perspective view of exemplary structure for a valve 126 that may employ the throttling ball 118 of FIG. 4. This structure may include a valve body 128, typically made of metal. The valve body 128 may embody a ball-style valve, where the throttling ball 118 resides inside of a cavity 130. These types of valves may have one of several operative configurations that depend on the orientation of the throttling ball 118. In one implementation, the throttling ball 118 may have two distinct positions, for example, an open position or a closed position. Other implementations use the throttling ball 118 to decrease (or increase) flow through the device. In one implementation, the valve body 128 may include a central cylinder 132 that includes or forms the cavity 130. A pair of closures 134 with a through-bore 136 may secure to either side of the central cylinder 132. Fasteners F may be useful for this purpose. The closures 134 may have an end 138 that is flanged to couple with pipes or conduit to allow ingress and egress of material into the cavity 130. Other configurations for the end 138 may employ different connection features, like weld ends, pipe fittings, socket weld flanges, or ring joints. The valve 126 may also include an actuator shaft 140 that penetrate through the central cylinder 132 to engage with the throttling ball 118. An actuator may connect with the actuator shaft 140 to rotate the throttling ball 118 to its different positions.

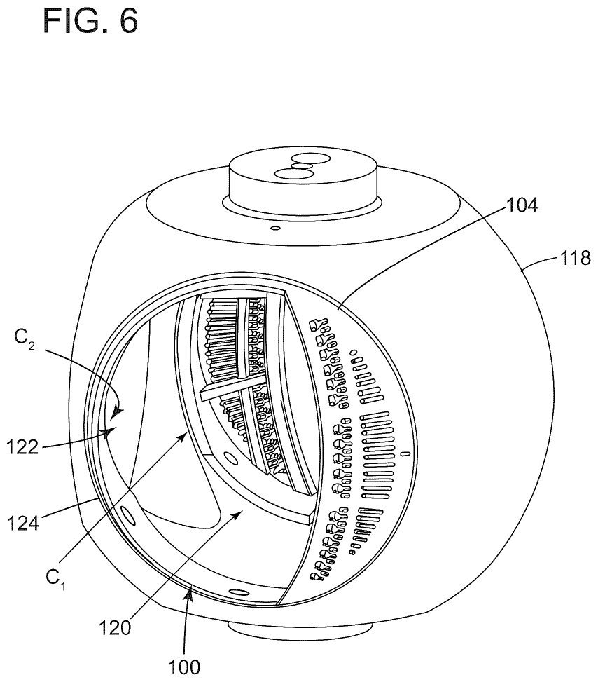

FIG. 6 depicts a perspective view of an example of the trim device 100 of FIG. 1. This example maintains continuity of the annular ring 104. The process may include steps to turn-down the outside surface 108 and heat the throttling ball 118 in order to insert, fit, and orient the annular ring 104 in position in the openings 122. The arcuate surface at the cutouts C₁, C₂ may align with the edge of the openings 122, as noted herein. Welds 124 may secure the annular ring 104 in position in the device.

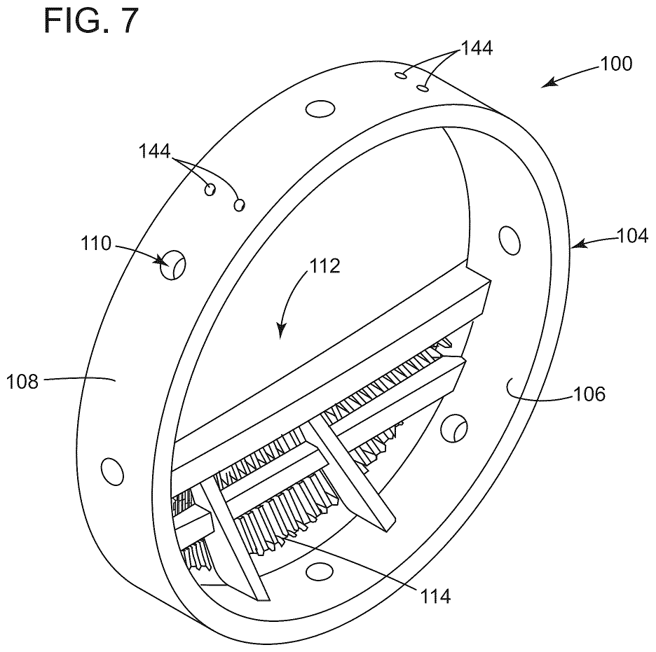

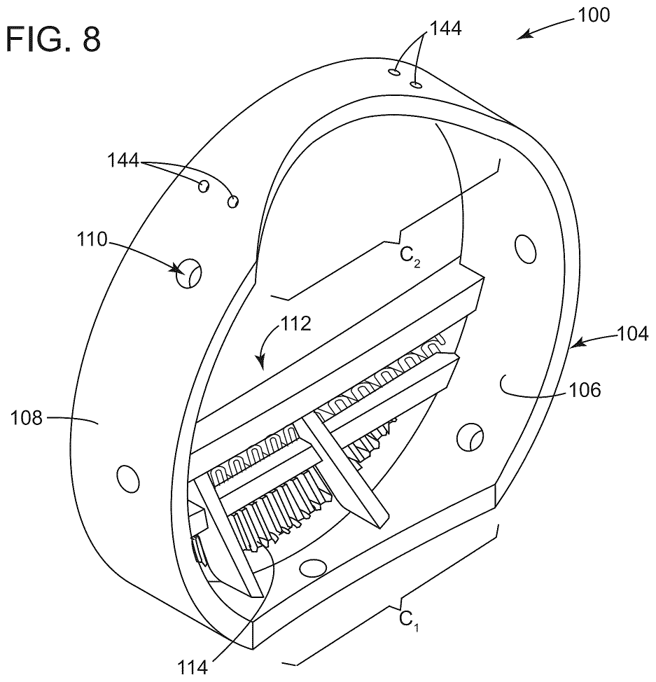

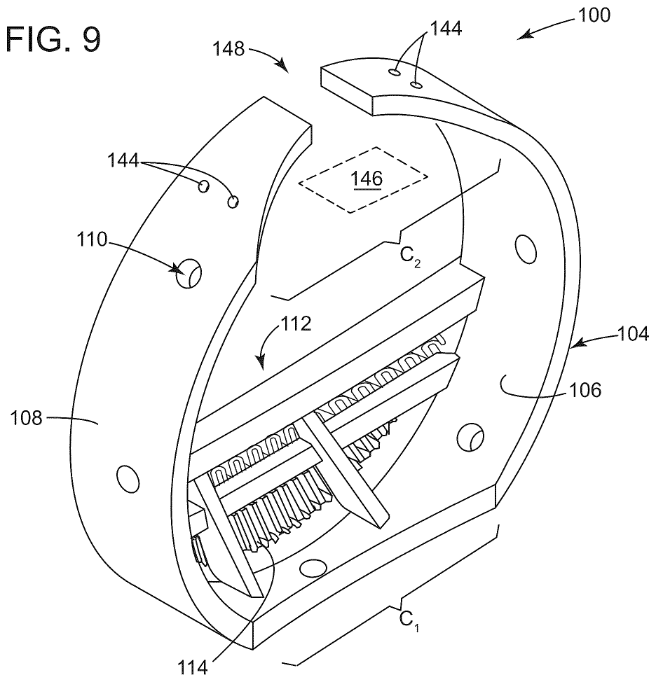

FIGS. 7, 8, and 9 depict perspective views of an example of the trim device 100 of FIG. 1. The process may include steps to turn-down the outside surface 108 and drill (or include) threaded holes 144. As best shown in FIG. 8, the steps may also form cutouts C₁, C₂. FIG. 9 shows the trim device 100 that results from steps that secure a tooling block 146 to the annular ring 104, preferably using fasteners that insert into the threaded holes 144. The tooling block 146 permits steps to remove a slot 148 from the annular ring 104. It may also allow manufacturers to more easily insert the annular ring 104 into the throttling ball 118.

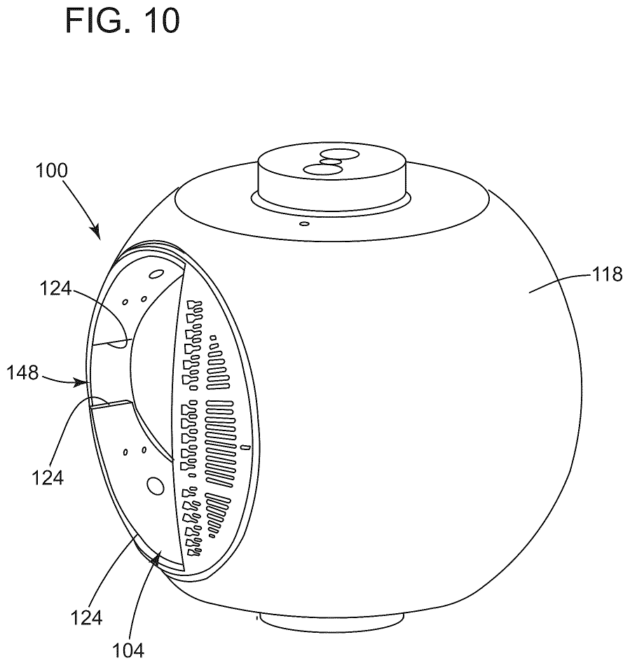

FIG. 10 depicts a perspective view of the trim device 100 of FIG. 7 in position in the throttling ball 118. In one implementation, the steps may heat the throttling ball 118 in order to insert, fit, an orient the annular ring 104 (with slot 148) in position in the openings 122. Welds 124 may secure the annular ring 104 in the device.

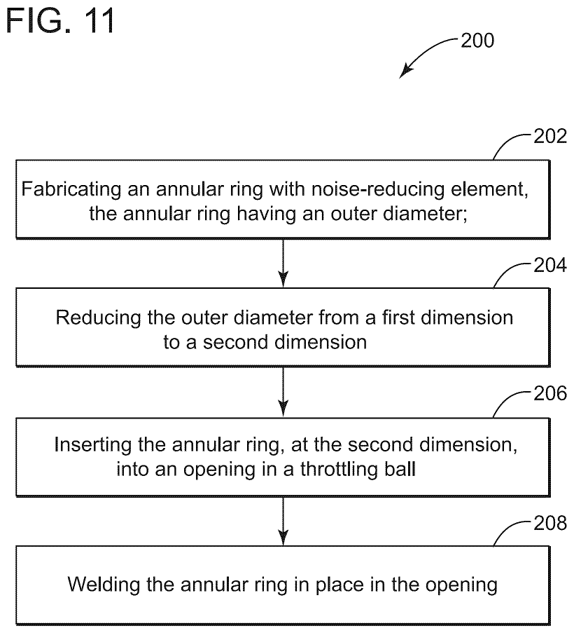

FIG. 11 depicts a flow diagram for an exemplary embodiment of a method 200 for fabricating trim and assembling throttling balls for use in ball valves. The method 200 may reduce lead times, costs, and avoid assembly problems because it does not heat or pre-heat the throttling ball. In one implementation, the method may include steps for (a) fabricating an annular ring with a noise-reducing element, the annular ring having an outer diameter (step 202) and (b) reducing the outer diameter from a first dimension to a second dimension (step 204). These steps may also include steps for forming the cutouts, as well. As also shown, the method may also include steps for (c) inserting the annular ring, at the second dimension (at step 206), into an opening in the throttling ball (at step 208), and (d) welding the annular ring in place in the opening.

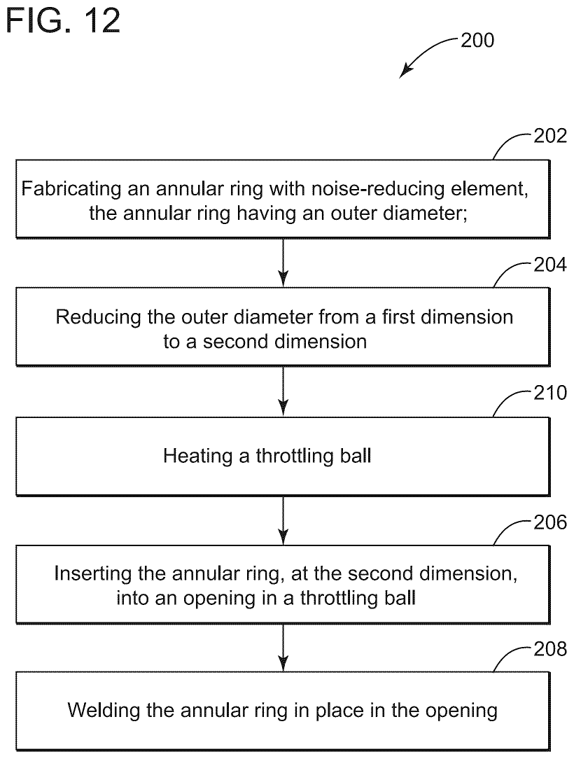

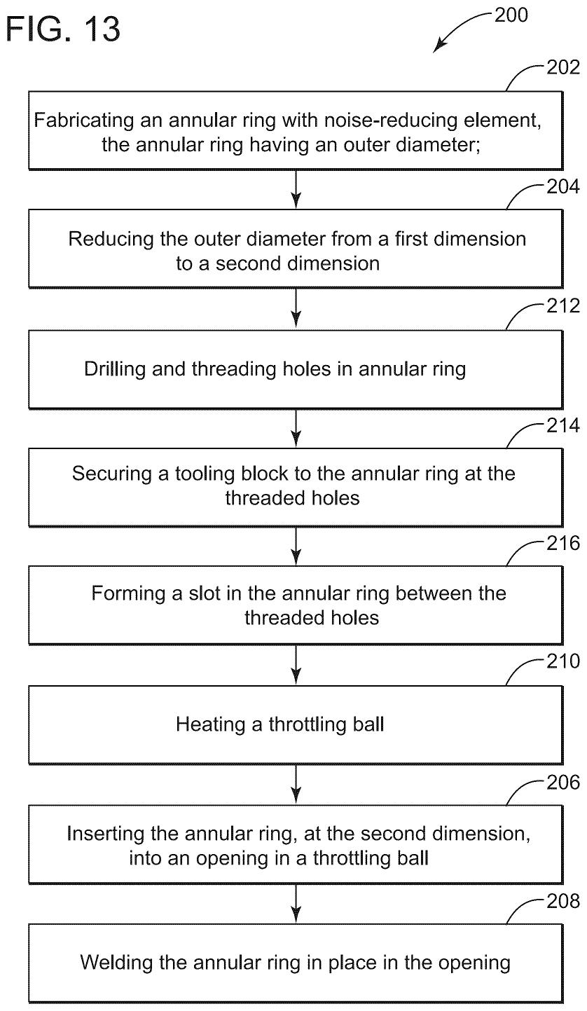

FIGS. 12 and 13 show other examples of the method 200. In FIG. 12, the method 200 may include steps for (c) heating the throttling ball (at step 210). The example of the method 200 in FIG. 13 may include steps for (f) drilling and threading holes in the annular ring (at step 212), (g) securing a tooling block to the annular ring (at step 214), and (h) forming a slot in the annular ring between the threaded holes.

In view of the foregoing, the improvements herein help to manufacture noise-suppressing trim and throttling balls for use in ball valves and like flow controls. These improvements forego any steps to heat or pre-heat the throttling ball, which may take several hours and require labor with skills or experience in this technique. The embodiments also avoid problems with rapid cooling of the throttling ball that can frustrate efforts to properly install the noise-reducing trim in its position.

The examples below may include certain elements or clauses that may be combined with other elements and clauses to describe embodiments contemplated within the scope and spirit of this disclosure. This disclosure may include and contemplate other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A valve, comprising:
a valve body;
a rotatable throttling ball disposed in the valve body, the rotatable ball having a hollow interior and a first opening exposing the hollow interior; and
a first annular ring with noise suppressing openings welded in place in the first opening.

2. The valve of claim 1, further comprising:
a slot in the first annular ring forming opposing terminating surfaces that are spaced part from one another by at least 90°.

3. The valve of claim 1, further comprising:
a slot in the first annular ring forming opposing terminating surfaces that are spaced part from one another by at least 180°.

4. The valve of claim 1, further comprising:
a slot in the first annular ring forming opposing terminating surfaces that are spaced part from one another by an angle in a range of between 120° and 180°.

5. The valve of claim 1, further comprising:
a slot in the first annular ring forming opposing terminating surfaces; and
a tooling block coupled to the annular ring and extending across the slot.

6. The valve of claim 1, further comprising:
a slot in the first annular ring forming opposing terminating surfaces;
threaded openings disposed proximate the opposing terminating surfaces; and
a tooling block coupled to the annular block at the threaded openings.

7. The valve of claim 1, further comprising
a cutout forming an arcuate surface in the annular ring.

8. The valve of claim 1, further comprising:
a cutout forming an arcuate surface in the annular ring that aligns with an edge of the first opening.

9. The valve of claim 1, further comprising:
a slot in the first annular ring forming opposing terminating surfaces; and
a cutout forming an arcuate surface in the first annular ring that aligns with an edge of the first opening.

10. The valve of claim 1, further comprising:
a slot in the first annular ring forming opposing terminating surfaces; and
a cutout diametrically opposing the slot and forming an arcuate surface in the first annular ring that aligns with an edge of the first opening.

11. The valve of claim 1, further comprising:
a pair of cutouts in the first annular ring that align with an edge of the first opening and the second opening.

12. The valve of claim 1, further comprising:
a second opening in the rotatable ball; and
a second annular ring with noise suppressing openings welded in place in the second opening.

13. The valve of claim 1, further comprising:
a second opening in the rotatable ball; and
a second annular ring with noise suppressing openings welded in place in the second opening,
wherein the first annular ring and the second annular ring comprise a slot that forms opposing terminating surfaces that are spaced part from one another by at least 90°.

14. The valve of claim 1,
a second opening in the rotatable ball; and
a second annular ring with noise suppressing openings welded in place in the second opening,
wherein the first annular ring and the second annular ring comprise,
a slot that forms opposing terminating surfaces, and
a cutout diametrically opposing the slot that forms an arcuate surface in both the fir annular ring and the second annular ring that aligns with an edge of the first opening and the second opening, respectively.

15. A method, comprising:
fabricating an annular ring with a noise-reducing element, the annular ring having an outer diameter;
reducing the outer diameter from a first dimension to a second dimension;
inserting the annular ring, at the second dimension, into an opening in a throttling ball; and
welding the annular ring in place in the opening.

16. The method of claim 15, further comprising:
forming cutouts in the annular ring, wherein the cutouts and the opening in the throttling ball have a radius that is the same.

17. The method of claim 15, wherein the second dimension is less than the radius of the opening.

18. A method, comprising:
providing a trim device comprising an annular ring with a noise suppressing openings, the annular ring having an outer surface with an outer diameter;
locating the trim device into an opening in a throttling ball, the opening having an inner diameter; and
welding the trim device into place in the opening,
wherein the outer diameter of the trim device is less than the inner diameter of the opening.

19. The method of claim 18, further comprising:
turning down the outer surface of the trim device to the outer diameter.

20. The method of claim 18, further comprising:
forming cutouts in the trim device, the cutouts having a radius that is the same as the inner diameter of the opening.
